(19) United States
(12) Patent Application Publication
(10) Pub. No.: US 2026/0087648 A1
(43) Pub. Date: Mar. 26, 2026

(54) ALL DAY LOCALIZATION

(71) Applicant: Apple Inc., Cupertino, CA (US)

(72) Inventors: Jai Prakash, Santa Clara, CA (US); Joseph A. Menke, Cupertino, CA (US); Lina M. Paz-Perez, Santa Clara, CA (US); Jose Maria Facil Ledesma, San Francisco, CA (US); Huiwen Guo, Newark, CA (US); Florian Mahlknecht, San Francisco, CA (US)

(21) Appl. No.: 19/323,354

(22) Filed: Sep. 9, 2025

Related U.S. Application Data
(60) Provisional application No. 63/698,121, filed on Sep. 24, 2024.

(51) Int. Cl. G06T 7/246; G06T 7/73

(52) U.S. Cl. CPC G06T 7/248; G06T 7/74; G06T 2207/30241; G06T 2207/30244

(57) ABSTRACT

Various implementations disclosed herein include devices, systems, and methods that perform a localization process that corrects drift occurring in odometry pose tracking. For example, a process may include tracking a device based on motion data obtained via motion sensors. The tracking may include determining position and orientation estimates over time. During the tracking drift comprising differences in the position and orientation estimates relative to actual positions and orientations of the device may develop. The process may further include obtaining two-dimensional 2D image data from cameras while the device is within a three-dimensional (3D) environment and determine a corrected position and orientation of the device based on the 2D image data and additional information from the motion data. The additional information may be indicative of a scale of the 2D image data. The process may further include correcting the drift based on the corrected position and orientation of the device.

### CROSS REFERENCE TO RELATED APPLICATIONS

This application claims the benefit of U.S. Provisional Application Ser. No. 63/698,121 filed Sep. 24, 2024, which is incorporated herein in its entirety.

### TECHNICAL FIELD

The present disclosure generally relates to systems, methods, and devices that that enable a localization process that corrects drift occurring in motion sensor-based pose tracking.

### BACKGROUND

Existing localization systems may be improved with respect to simplicity, power consumption, and accuracy.

### SUMMARY

Various implementations disclosed herein include systems, methods, and devices that use image and sensor data to enable a localization process configured to correct drift occurring in motion sensor-based odometry pose tracking by periodically enabling an accurate, low-power, six degrees of freedom (6DOF) localization process. In some implementations, periodic 6DOF localization may be achieved without using a high-power, three-dimensional (3D) feature point-based tracking that is typically used in traditional simultaneous localization and mapping (SLAM) processes. In contrast, periodic 6DOF localization may be achieved via an optimization process that utilizes low power two-dimensional (2D) image feature matching and additional information from another source from which missing scale information may be derived.

In some implementations, a low power 2D image feature matching process may include matching 2D features in a query image with 2D features in a closest keyframe image. In some implementations, a 2D image feature matching process may provide adequate information for five degrees of freedom (5DOF) localization. Subsequently, additional information from another source from which missing scale info may be derived may be used to enable 5DOF localization be extended to 6DOF localization. In some implementations, a 2D image feature matching process may use visual/epipolar constraints.

In some implementations, additional information from which scale is derived may come from odometry such as, inter alia, neural odometry. In some implementations, odometry may be used to provide device position and orientation estimates that include drift but provides information from which sufficiently accurate scale estimates may be determined. In some implementations, A result of the localization process may be a pose graph that accurately and efficiently tracks a path of an electronic device in a physical environment.

In some implementations, an electronic device has one or more motion sensors, one or more cameras, and a processor (e.g., one or more processors) that executes instructions stored in a non-transitory computer-readable medium to perform a method. The method performs one or more steps or processes. In some implementations, the electronic device is tracked based on motion data obtained via the one or more motion sensors. The tracking comprises determining a series of position and orientation estimates over time in which later estimates in the series depend upon one or more earlier estimates in the series. In some implementations, drift develops over time during the tracking. The drift may include differences in the position and orientation estimates relative to actual positions and orientations of the electronic device. In some implementations, 2D image data is obtained from the one or more cameras while the electronic device is within a 3D environment. In some implementations, a corrected position and orientation of the electronic device is determined based on the 2D image data and additional information from the motion data. The additional information is indicative of a scale of the 2D image data. In some implementations, the drift is corrected based on the corrected position and orientation of the electronic device.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment, in accordance with some implementations.

FIGS. 2A and 2B illustrate views of a process for matching a query frame to a keyframe image, in accordance with some implementations.

FIG. 3 illustrates an optimized localization process configured to correct drift associated with odometry-based pose tracking to recover a scale of a scene via usage of image features to track a path device movement within an environment, in accordance with some implementations.

FIG. 4 illustrates an example environment for implementing a localization process that corrects drift occurring in motion sensor-based pose tracking to generate a pose graph representation, in accordance with some implementations.

FIG. 5 is a flowchart representation of an exemplary method that implements a localization process that corrects drift occurring in odometry motion sensor-based pose tracking, in accordance with some implementations.

FIG. 6 is an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

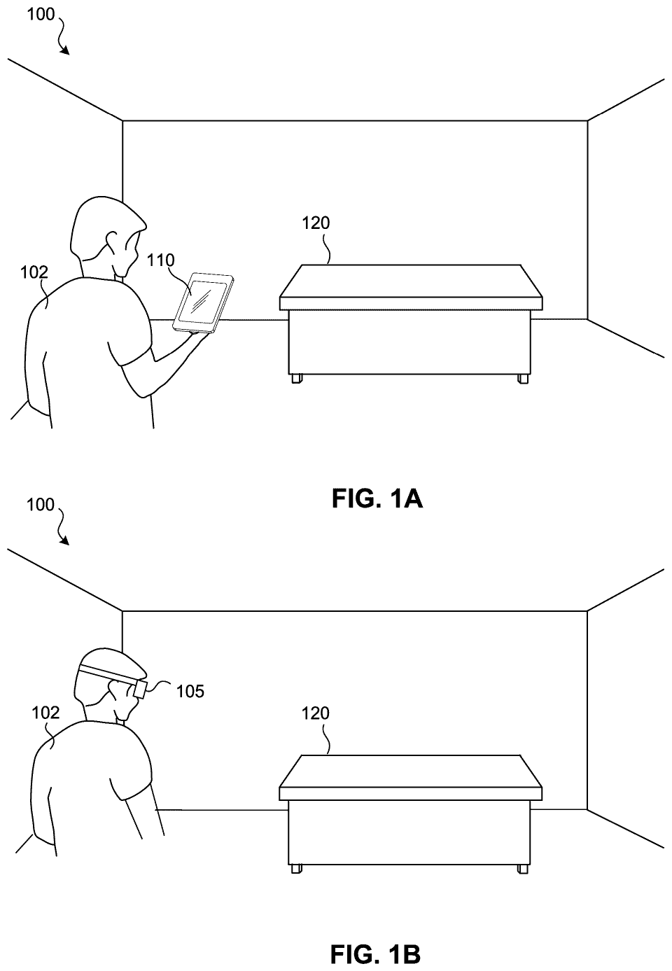

FIGS. 1A-B illustrate exemplary electronic devices 105 and 110 operating in a physical environment 100. In the example of FIGS. 1A-B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as a head mounted device (HMD)) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, an optimized localization process configured to correct drift associated with odometry-based pose tracking may be implemented to recover a scale of a scene via usage of image features without requiring the use of any 3D feature points. For example, a localization process may include tracking an electronic device (e.g., an HMD, a mobile device, etc.) based on motion data obtained via a motion sensor(s) of the electronic device. In some implementations, a tracking process may include determining a series of position and orientation (e.g., pose) estimates over a time period in which subsequent position and orientation estimates in the series may depend upon one or more previously obtained estimates in the series. In some implementations, drift may develop over time during the tracking process. For example, drift includes differences with respect to position and orientation estimates relative to actual positions and orientations of the electronic device.

In some implementations, 2D image data may be obtained from a camera(s) of the electronic device while the electronic device is within a three-dimensional (3D) environment.

In some implementations, a corrected position and orientation of the electronic device may be determined based on the 2D image data and additional information from the motion data. The additional information may be indicative of a scale of the 2D image data. For example, the additional information may include approximate camera positions from motion-data based estimates from which a scale may be inferred.

In some implementations, an optimized localization process may not require explicitly determining scale but information that is indicative of scale may be used to resolve a 6th DOF. In some implementations, determining a corrected pose may involve explicitly or implicitly determining scale using a direction of the device (e.g., determined from the 2D image data) and information associated with a relative translation between query and retrieved image data from motion data estimates. For example, parallax may be used to explicitly or implicitly compute scale via triangulation.

In some implementations, drift may be corrected based on a corrected position and orientation of the electronic device.

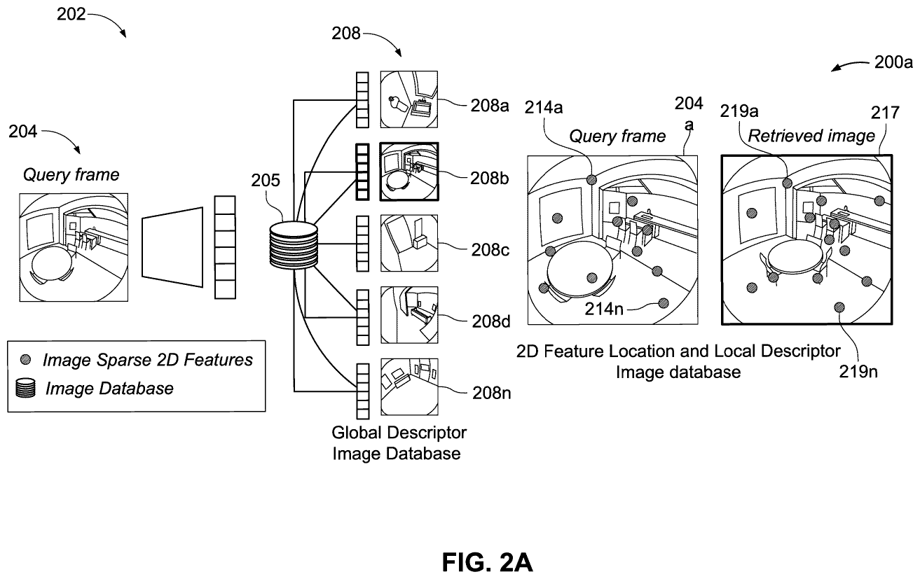

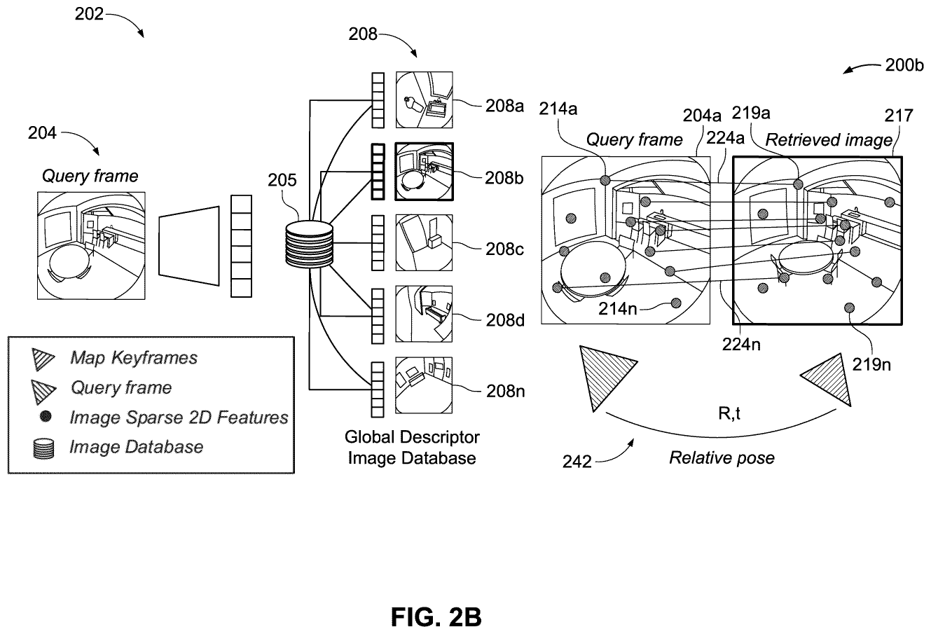

FIGS. 2A and 2B illustrate views 200a and 200b of a process 202 for matching a query frame 204 to a keyframe image 208b of a plurality of keyframe images 208 (including keyframe images 208a . . . 208n representing a room) of a map database 205, in accordance with some implementations. Process 202 enables a localization process that corrects drift occurring in odometry (e.g., motion sensor-based) pose tracking by periodically enabling an accurate, low-power, 6DOF localization process within an environment (e.g., a room as illustrated in FIGS. 2A and 2B) as described with respect to FIG. 1, supra.

FIG. 2A illustrates view 200a representing process 202 occurring during a first time period. In the example of FIG. 2A, a matching process between query frame 204 and keyframe images 208 from database 205 is executed. In response, query frame 204 and an image 208 are selected and epipolar constraints (e.g., correspondences between 2 views of a same scene of, for example, a room) of 2D image data are applied to query frame 204 to produce a query frame 204a comprising sparse 2D features 214a . . . 214n. Likewise, epipolar constraints are applied to retrieved image 208b of keyframe images 208 to produce a retrieved image 217 comprising sparse 2D features 219a . . . 219n. The epipolar constraints are used to determine position and orientation of an electronic device (such as an HMD within a room) by performing a 2D image feature matching process that includes matching 2D features (sparse 2D features 214a . . . 214n) of query frame 204a with 2D features (sparse 2D features 219a . . . 219n) of a closest keyframe image (e.g., keyframe images 208a . . . 208n) of the image data as further described with respect to FIG. 2B, infra.

FIG. 2B illustrates view 200b representing process 202 occurring during a second time period occurring subsequent to the first time period described with respect to FIG. 2A. In the example of FIG. 2B, a matching process between query frame 204 and keyframe images 208 from database 205 is further executed. In response, some of sparse 2D features 214a . . . 214n (of query frame 204a) are matched (via connections 224a . . . 224n) to some of sparse 2D features 219a . . . 219n (of retrieved image 217). For example, sparse 2D feature 214a is matched to sparse 2D feature 219a as both features are represented at similar locations within the environment.

Accordingly, process 202 implements an optimization process that uses low power 2D image feature matching (matching 2D features 214a . . . 214n in query image 204a to 2D image features 219a . . . 219n in a closest keyframe image such as retrieved image 217) and additional information from another source from which missing scale information may be derived. For example, the additional information may include approximate camera positions from motion-data based estimates from which scale may be inferred or derived.

In some implementations, 2D image feature matching may use visual/epipolar constraints and provide information to perform 5DOF localization. The additional information associated with scale enables 5DOF localization to be extended to 6DOF localization. In some implementations, the additional information from which scale is derived may be obtained from odometry providing estimates that involve drift but additionally provide information from which sufficiently accurate scale estimates may be determined resulting in generation of a pose graph representation that accurately and efficiently tracks a path of a device in a physical environment.

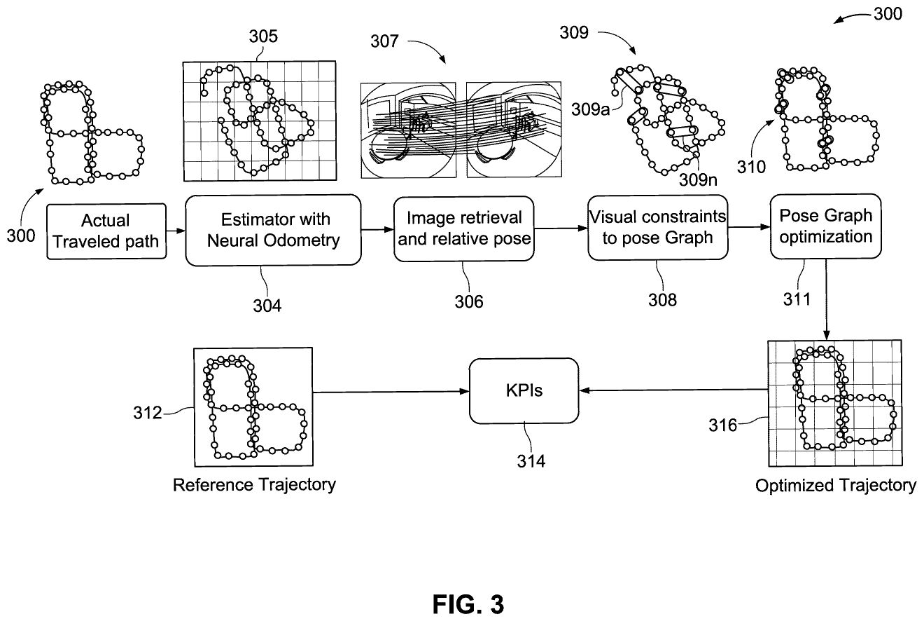

FIG. 3 illustrates an optimized localization process 300 configured to correct drift associated with odometry-based pose tracking to recover a scale of a scene via usage of image features to track a device movement path within an environment, in accordance with some implementations. Optimized localization process 300 obtains as input, an actual traveled path 302 associated with device movement within an environment such as a room. At block 304, the actual traveled path 302 is analyzed with respect to an estimator 305 associated with neural odometry for use with an image 307 retrieval and relative pose graph determination process at block 306 as described with respect to FIGS. 2A and 2B, supra. At block 308, visual constraints 309a . . . 309n are applied to a pose graph representation 309 for pose graph 310 optimization at block 311. The pose graph optimization results in an optimized trajectory 316 (for device movement). The optimized trajectory 316 is analyzed with respect to a reference trajectory 312 to produce key performance indicators (KPIs) associated with optimized localization process 300. Accordingly, a pose graph representation associated with a relative pose (e.g., relative pose 242 (R,t) of FIG. 2B) that accurately and efficiently tracks the path of a device in a physical environment is generated.

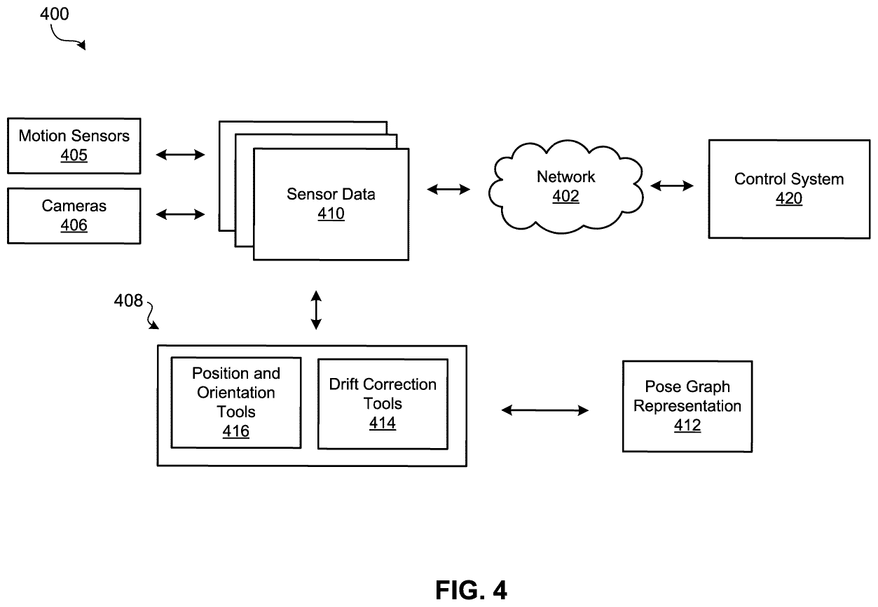

FIG. 4 illustrates an example environment 400 for implementing a localization process (via, for example, an electronic device such as a wearable device being worn by a user) that corrects drift occurring in motion sensor-based pose tracking to generate a pose graph representation 412, in accordance with some implementations. The example environment 400 includes motion sensors 405 (e.g., of electronic devices 105 or 110 FIG. 1) such as, inter alia, inertial measurement unit (IMU) sensors, etc., cameras 406, sensor data 410, tools/software 408, and a control system 420 that, in some implementations, communicates over a data communication network 402, e.g., a local area network (LAN), a wide area network (WAN), the Internet, a mobile network, or a combination thereof.

Tools/software 408 comprise position and orientation tools 416 and drift correction tools 412.

In some implementations, example environment 400 is configured to enable tools/software 408 to recover a scale of a scene using image features, without requiring any 3D feature points using epipolar constraints from multiple images and neural odometry to obtain a rough metric scale. Subsequently, a pose graph representation with epipolar constraints may be generated.

During the localization process, motion sensors 405 (of an electronic device such as a wearable device and/or within environment 400) may be activated to monitor and track the electronic device and resulting sensor data 410 is obtained. For example, sensors 405 may be configured to monitor motion such as, inter alia, acceleration, orientation, angular rates, gravitational forces, etc. Monitoring and tracking the wearable device may include determining a series of position and orientation (e.g., pose) estimates over time such that drift may develop over time during the monitoring and tracking. Drift represents differences in position and orientation estimates relative to actual positions and orientations of the electronic device.

In some implementations during the localization process, cameras 406 of the electronic device and/or within environment 400) may be activated to obtain image data (e.g., 2D image data of sensor data 410) of a 3D environment (e.g., a physical environment) associated with electronic device movement.

In some implementations, a corrected position and orientation of the electronic device (within the 3D environment) may be obtained, via position and orientation tools 416, based on the image data and information obtained from the motion data of sensor data 410. The information obtained from the motion data may be representative of a scale of the image data. For example, the information may include approximate camera positions from the position and orientation estimates from which scale may be derived. In some implementations, actual scale may not be explicitly determined but the information representative of scale may be used to resolve a 6th DOF representation. In some implementations, determining a corrected position and orientation of the electronic device may involve explicitly or implicitly determining scale using device direction (obtained from the image data) and data associated with a relative translation between query images and retrieved images associated with the position and orientation estimates. For example, parallax may be used to explicitly or implicitly compute scale via triangulation.

In some implementations, drift may be corrected (via execution of drift correction tools 414) based on the corrected position and orientation of the electronic device.

In some implementations, a pose graph representation 412 is generated to track a path of the electronic device in the 3D environment. The pose graph representation 412 may be generated based on the corrected position and orientation of the electronic device and the corrected scale.

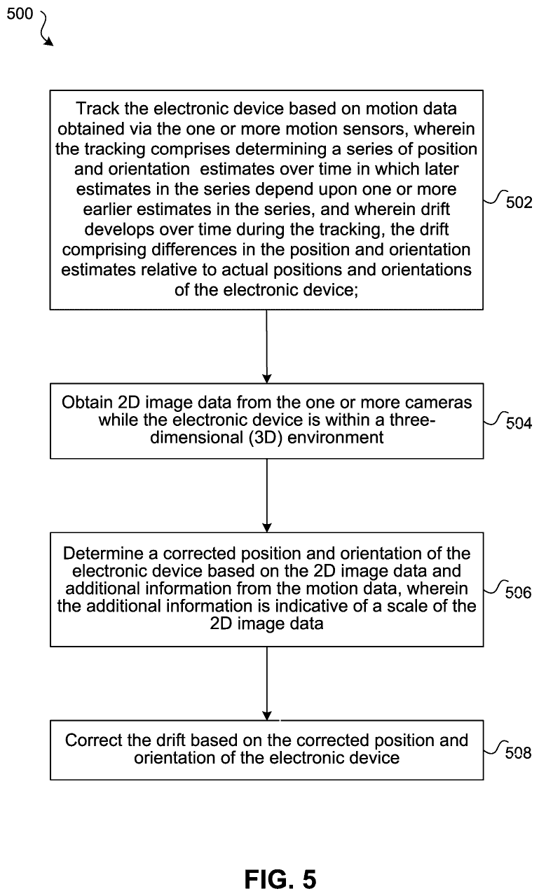

FIG. 5 is a flowchart representation of an exemplary method 500 that implements a localization process that corrects drift occurring in odometry motion sensor-based pose tracking, in accordance with some implementations. In some implementations, the method 500 is performed by an electronic device, such as an HMD, a camera, mobile device, desktop, laptop, or server device. In some implementations, the electronic device has a screen for displaying images and/or a screen for viewing stereoscopic images such as a head-mounted display (an HMD such as e.g., device 105 of FIG. 1). In some implementations, the method 500 is performed by processing logic, including hardware, firmware, software, or a combination thereof. In some implementations, the method 400 is performed by a processor executing code stored in a non-transitory computer-readable medium (e.g., a memory). Each of the blocks in the method 500 may be enabled and executed in any order.

At block 502, the method 500 tracks an electronic device based on motion data obtained via one or more motion sensors of the electronic device. For example, motion data may be obtained from motion sensors 405 as described with respect to FIG. 4. In some implementations, tracking the electronic device may include determining a series of position and orientation estimates over time in which later estimates in the series depend upon one or more earlier estimates in the series of position and orientation estimates. For example. position and orientation estimates may comprise pose estimates as described with respect to FIGS. 3 and 4. In some implementations, drift may develop over time during the tracking process. Drift may include differences in the position and orientation estimates relative to actual positions and orientations of the electronic device.

At block 504, the method 500 obtains 2D image data from one or more cameras (e.g., of the electronic device) while the electronic device is within a three-dimensional (3D) environment. For example, 2D image data may be retrieved from cameras such as cameras 406 as described with respect to FIG. 4.

At block 506, the method 500 determines a corrected position and orientation of the electronic device based on the 2D image data and additional information obtained from the motion data. The additional information may be indicative of a scale of the 2D image data. For example, the information may include approximate camera positions from the position and orientation estimates from which scale may be derived as described with respect to FIGS. 3 and 4.

In some implementations, determining the corrected position and orientation of the electronic device may include performing a 2D image feature matching process that includes matching 2D features of a query image to 2D features of a closest keyframe image of the image data. For example, a 2D image feature matching process that includes matching 2D features (such as sparse 2D features 214a . . . 214n) of query frame 204a with 2D features (such as sparse 2D features 219a . . . 219n) of a closest keyframe image (e.g., keyframe images 208a . . . 208n) of image data as described with respect to FIGS. 2A and 2B. In some implementations, the 2D image feature matching process uses epipolar constraints from the 2D image data.

In some implementations, the 2D image feature matching process may enable 5DOF localization of the electronic device as described with respect to FIG. 2B.

In some implementations, the additional information may enable the 5DOF localization to be extended to 6DOF localization as described with respect to FIG. 2B.

In some implementations, the additional information may be derived from an odometry (e.g., neural odometry) that includes the drift and is configured to determine an estimate of the scale of the 2D image data.

In some implementations, determining the series of position and orientation estimates may include determining the scale using a direction of the electronic device and relative translation information between a query image and a retrieved image obtained from the motion data as described with respect to FIG. 4.

In some implementations, a parallax process may be used to compute the scale via triangulation.

At block 508, the method 500 enables a process to correct the drift based on the corrected position and orientation of the electronic device and based on the corrected position and orientation of the electronic device and the corrected scale, a pose graph representation (e.g., pose graph representation 412 of FIG. 4) enabled to track a path of the electronic device in the 3D environment may be generated.

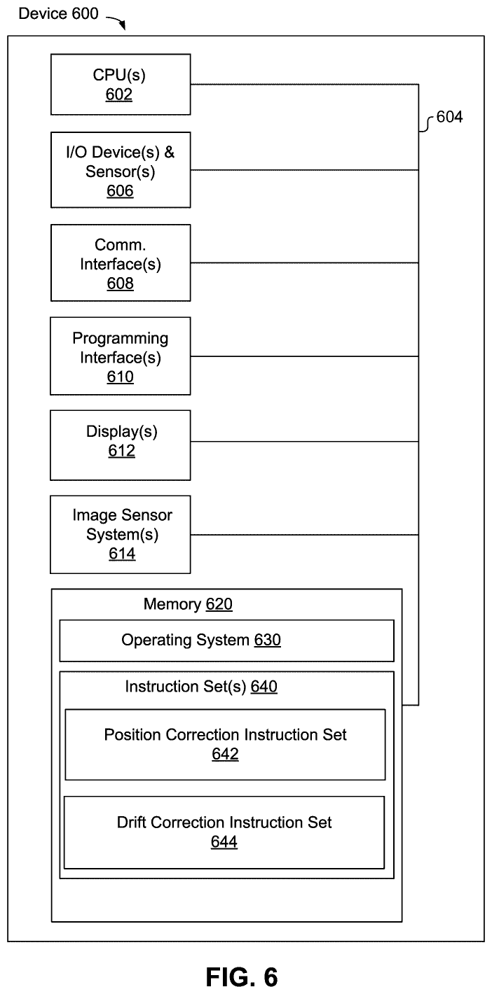

FIG. 6 is a block diagram of an example device 600. Device 600 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 600 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 610, one or more displays 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 612 are configured to present a view of a physical environment or a graphical environment to the user. In some implementations, the one or more displays 612 are configured to present content (determined based on a determined user/object location of the user within the physical environment) to the user. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 612 correspond to diffractive, reflective, polarized, holographic, etc. waveguide displays. In one example, the device 600 includes a single display. In another example, the device 600 includes a display for each eye of the user.

In some implementations, the one or more image sensor systems 614 are configured to obtain image data that corresponds to at least a portion of the physical environment 105. For example, the one or more image sensor systems 614 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 600 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 600 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 600.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 includes position correction instruction set 642 and a drift correction instruction set 644. The instruction set(s) 640 may be embodied as a single software executable or multiple software executables.

The position correction instruction set 642 is configured with instructions executable by a processor to determining a corrected position and orientation of an electronic device based on 2D image data and scale information from motion data.

The drift correction instruction set 644 is configured with instructions executable by a processor to correcting the drift (i.e., differences in position and orientation estimates) based on the corrected position and orientation of the electronic device.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor, one or more motion sensors, and one or more cameras:
tracking the electronic device based on motion data obtained via the one or more motion sensors, wherein the tracking comprises determining a series of position and orientation estimates over time in which later estimates in the series depend upon one or more earlier estimates in the series, and wherein drift develops over time during the tracking, the drift comprising differences in the position and orientation estimates relative to actual positions and orientations of the electronic device;
obtaining 2D image data from the one or more cameras while the electronic device is within a three-dimensional (3D) environment;
determining a corrected position and orientation of the electronic device based on the 2D image data and additional information from the motion data, wherein the additional information is indicative of a scale of the 2D image data; and
correcting the drift based on the corrected position and orientation of the electronic device.

2. The method of claim 1, wherein the additional information comprises at least one approximate camera position corresponding to the position and orientation estimates from which the scale is derived.

3. The method of claim 1, wherein said determining the corrected position and orientation of the electronic device comprises performing a 2D image feature matching process that includes matching 2D features of a query image to 2D features of a closest keyframe image of the image data.

4. The method of claim 3, wherein the 2D image feature matching process uses epipolar constraints from the 2D image data.

5. The method of claim 3, wherein the 2D image feature matching process enables five degrees of freedom (5DOF) localization of the electronic device.

6. The method of claim 3, wherein the additional information enables the 5DOF localization to be extended to six degrees of freedom (6DOF) localization.

7. The method of claim 3, wherein the additional information is derived from an odometry that includes the drift and determines an estimate of the scale of the 2D image data.

8. The method of claim 1, wherein said determining the series of position and orientation estimates comprises determining the scale using a direction of the electronic device and relative translation information between a query image and a retrieved image obtained from the motion data.

9. The method of claim 8, wherein said determining the scale comprises performing a parallax process to compute the scale via triangulation.

10. The method of claim 1, further comprising:
based on the corrected position and orientation of the electronic device and the corrected scale, generating a pose graph enabled to track a path of the electronic device in the 3D environment.

11. An electronic device comprising:
a non-transitory computer-readable storage medium;
one or more motion sensors;
one or more cameras; and
one or more processors coupled to the non-transitory computer-readable storage medium, wherein the non-transitory computer-readable storage medium comprises program instructions that, when executed on the one or more processors, cause the electronic device to perform operations comprising:
tracking the electronic device based on motion data obtained via the one or more motion sensors, wherein the tracking comprises determining a series of position and orientation estimates over time in which later estimates in the series depend upon one or more earlier estimates in the series, and wherein drift develops over time during the tracking, the drift comprising differences in the position and orientation estimates relative to actual positions and orientations of the electronic device;
obtaining 2D image data from the one or more cameras while the electronic device is within a three-dimensional (3D) environment;
determining a corrected position and orientation of the electronic device based on the 2D image data and additional information from the motion data, wherein the additional information is indicative of a scale of the 2D image data; and
correcting the drift based on the corrected position and orientation of the electronic device.

12. The electronic device of claim 11, wherein the additional information comprises at least one approximate camera position corresponding to the position and orientation estimates from which the scale is derived.

13. The electronic device of claim 11, wherein said determining the corrected position and orientation of the electronic device comprises performing a 2D image feature matching process that includes matching 2D features of a query image to 2D features of a closest keyframe image of the image data.

14. The electronic device of claim 13, wherein the 2D image feature matching process uses epipolar constraints from the 2D image data.

15. The electronic device of claim 13, wherein the 2D image feature matching process enables five degrees of freedom (5DOF) localization of the electronic device.

16. The electronic device of claim 13, wherein the additional information enables the 5DOF localization to be extended to six degrees of freedom (6DOF) localization.

17. The electronic device of claim 13, wherein the additional information is derived from an odometry that includes the drift and determines an estimate of the scale of the 2D image data.

18. The electronic device of claim 11, wherein said determining the series of position and orientation estimates comprises determining the scale using a direction of the electronic device and relative translation information between a query image and a retrieved image obtained from the motion data.

19. The electronic device of claim 18, wherein said determining the scale comprises performing a parallax process to compute the scale via triangulation.

20. A non-transitory computer-readable storage medium, storing program instructions executable by one or more processors to perform operations comprising:
at an electronic device having a processor, one or more motion sensors, and one or more cameras:
tracking the electronic device based on motion data obtained via the one or more motion sensors, wherein the tracking comprises determining a series of position and orientation estimates over time in which later estimates in the series depend upon one or more earlier estimates in the series, and wherein drift develops over time during the tracking, the drift comprising differences in the position and orientation estimates relative to actual positions and orientations of the electronic device;
obtaining 2D image data from the one or more cameras while the electronic device is within a three-dimensional (3D) environment;
determining a corrected position and orientation of the electronic device based on the 2D image data and additional information from the motion data, wherein the additional information is indicative of a scale of the 2D image data; and
correcting the drift based on the corrected position and orientation of the electronic device.
